(19) United States
(12) Patent Application Publication
(10) Pub. No.: US 2010/0225739 A1
(43) Pub. Date: Sep. 9, 2010

(54) METHOD OF REDUCING EFFECTIVE PIXEL PITCH IN ELECTROHOLOGRAPHIC DISPLAY AND ELECTROHOLOGRAPHIC DISPLAY INCLUDING THE SAME

(75) Inventors: Alok Govil, Santa Clara, NY (US); Remus Albu, Forest Hills, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/303,968

(22) PCT Filed: May 29, 2007
(86) PCT No.: PCT/IB07/52017

§ 371 Date: Dec. 9, 2008

Related U.S. Application Data
(60) Provisional application No. 60/812,354, filed on Jun. 9, 2006.

(51) Int. Cl. H04N 13/00

(52) U.S. Cl. 348/40; 348/E13.001

(57) ABSTRACT

An electroholographic display system (500) includes a coherent light source (130) adapted to produce a coherent, collimated light beam, a spatial light modulator (SLM) (120) adapted to modulate the light beam, an optical unit (350, 450) in an optical path between the SLM (120) and the image plane (580) where a holographic image is projected. The optical unit (350, 450), which may include a pair of convex lenses (460, 470), operates to effectively decrease the pitch (220) of the pixels (210) of the SLM (120). This allows the electroholographic display system (500) to exhibit a desired range of diffraction even when it includes an SLM (120) whose pixel pitch (220) is larger than would otherwise be required for the desired diffraction range.

This invention pertains to electroholographic display systems, and more particularly to a method of reducing the effective pixel pitch in an electroholographic display, and an electroholographic display with a reduced effective pixel pitch.

Recently electroholographic display systems have been developed to generate full three-dimensional (“3-D”) reconstructions of images. There is a strong interest in developing electroholographic display systems for reproducing moving images in 3-D, such as 3-D television. A real-time electroholography system by computer-generated hologram (CGH) is said to be an ultimate 3-D television because holography is the only technology that can directly record and reconstruct a 3-D image.

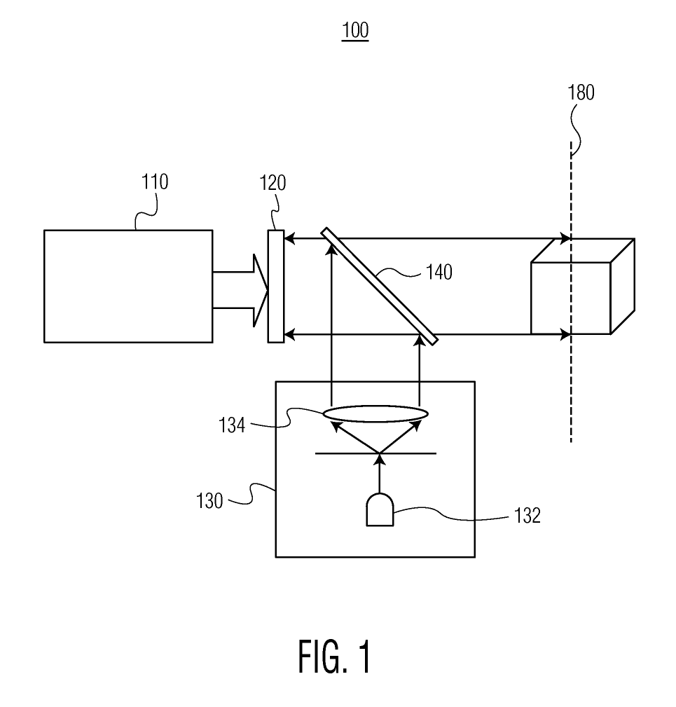

FIG. 1 shows one embodiment of an electroholographic display system 100. Electroholographic display system 100 comprises a processor and driver unit 110, spatial light modulator (SLM) 120, coherent light source 130, and a beamsplitter 140. Processor and driver unit 110 may comprise separate circuits or components of the processor and the driver, and may include memory such as read only memory (ROM), random access memory (RAM), etc. Beneficially, software for executing various algorithms is stored in memory in processor and driver unit 110. Beneficially, SLM 120 is a reflective liquid crystal display (LCD), such as a reflective liquid crystal on silicon (LCOS) device. In one embodiment, coherent light source 130 comprises a laser emitting diode (LED) 132 and collimation optics 134.

Operationally, LED 132 provides a light beam to collimation optics 134 which collimates and sizes the light beam appropriately for SLM 120. The coherent, collimated light beam from light source 130 is provided to beamsplitter 140, which directs the coherent, collimated light beam onto SLM 120. Meanwhile, processor and driver unit 110 generates hologram data and applies the data to drive the pixels of SLM 120. In response to the data driving each of the pixels of SLM 120, the coherent, collimated light beam is spatially modulated to generate a spatially modulated light beam which is reflected back to beamsplitter 140. Beamsplitter 140 passes the spatially modulated light beam therethrough to an image plane 180 where the hologram is formed.

However, some problems remain with such an electroholographic display system. One problem is the need for an SLM that is small enough to display the minute fringe pattern needed for a hologram which can be viewed by human eyes with a relatively wide range. In holography, an image is reconstructed with diffracted light. Meanwhile, the distance between the two eyes in a typical human being is about 6.5 cm. For a satisfactory range of diffraction, therefore, an SLM needs to have a fine, minute pixel pitch—on the order of ˜1 μm. At present, unfortunately, there are no electronic display devices whose pixel pitch is ˜1 μm. However, in the case of a reflective LCD, there are devices with a pixel pitch on the order of 10 μm.

Accordingly, it would be desirable to provide a method of reducing the effective pixel pitch in an electroholographic display. It would further be desirable to provide an electroholographic display with a reduced effective pixel pitch.

In one aspect of the invention, an electroholographic display system includes: a coherent light source adapted to produce a coherent, collimated light beam; a spatial light modulator (SLM) adapted to receive and modulate the coherent collimated light beam to produce therefrom a modulated light beam, the SLM including a plurality of pixels having a pixel pitch of a₁; a processor and driver unit adapted to generate hologram data representing a holographic image and to apply appropriate drive signals to the pixels of the SLM to cause the SLM to modulate the coherent collimated light beam with the hologram data; and an optical unit disposed to receive the modulated light beam and to provide the holographic image, wherein the effective pixel pitch of the holographic image is a₂<a₁.

In another aspect of the invention, a method of displaying a holographic image includes: providing a coherent, collimated light beam to a spatial light modulator (SLM) comprising a plurality of pixels having a pixel pitch of a₁; applying appropriate drive signals to the pixels of the SLM to cause the SLM to modulate the coherent collimated light beam with hologram data to produce therefrom a modulated light beam; and processing the modulated light beam to provide a holographic image, wherein the effective pixel pitch of the holographic image is a₂<a₁.

FIG. 1 shows an electroholographic display system;

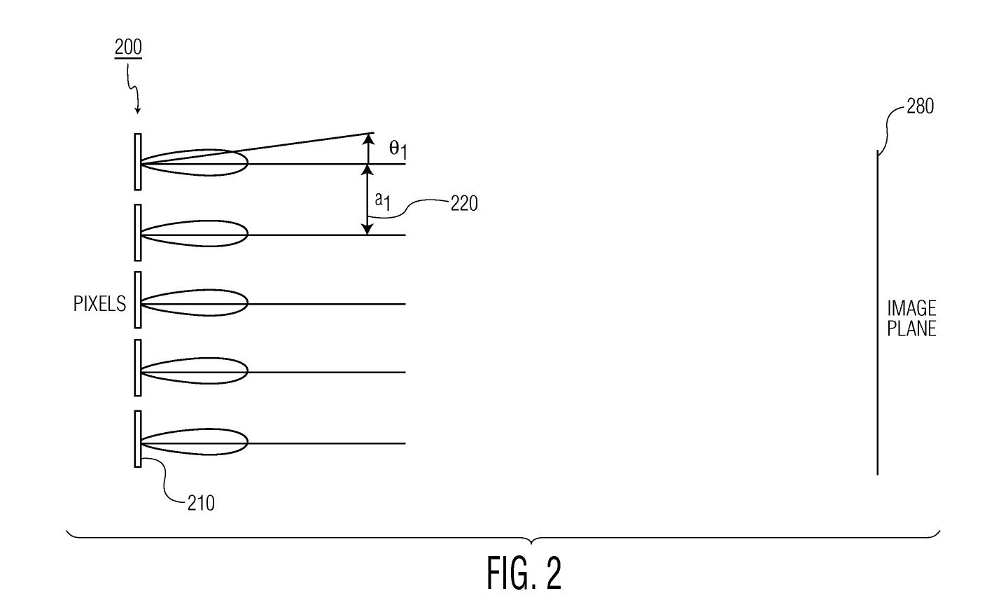

FIG. 2 illustrates pixels of a spatial light modulator (SLM), and an associated radiation pattern produced therefrom;

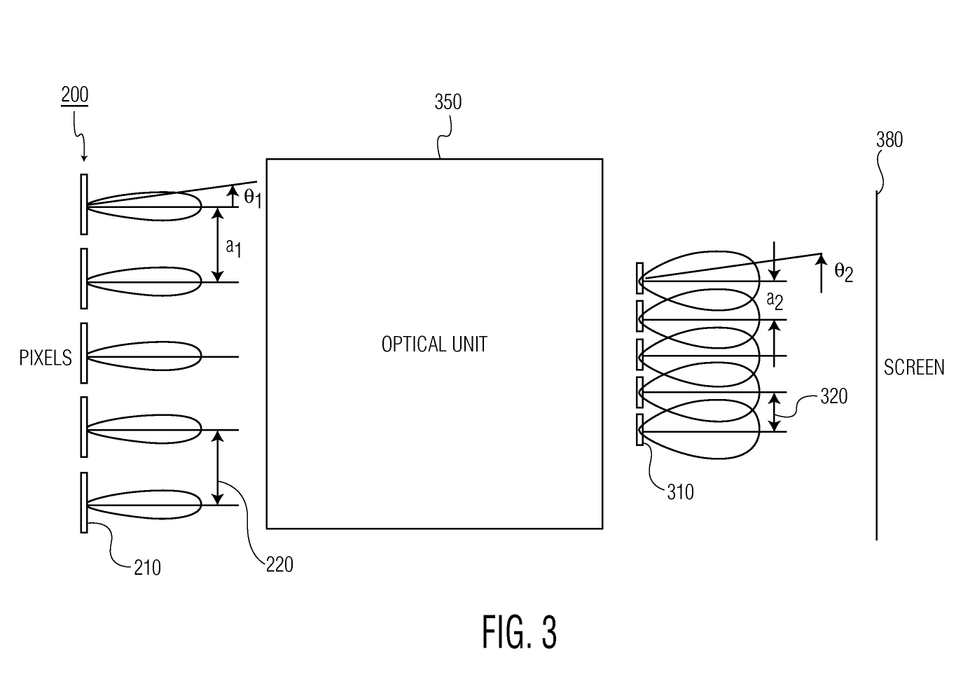

FIG. 3 shows one embodiment of an arrangement to provide an “effective pixel pitch” that is significantly reduced with respect to the actual pixel pitch;

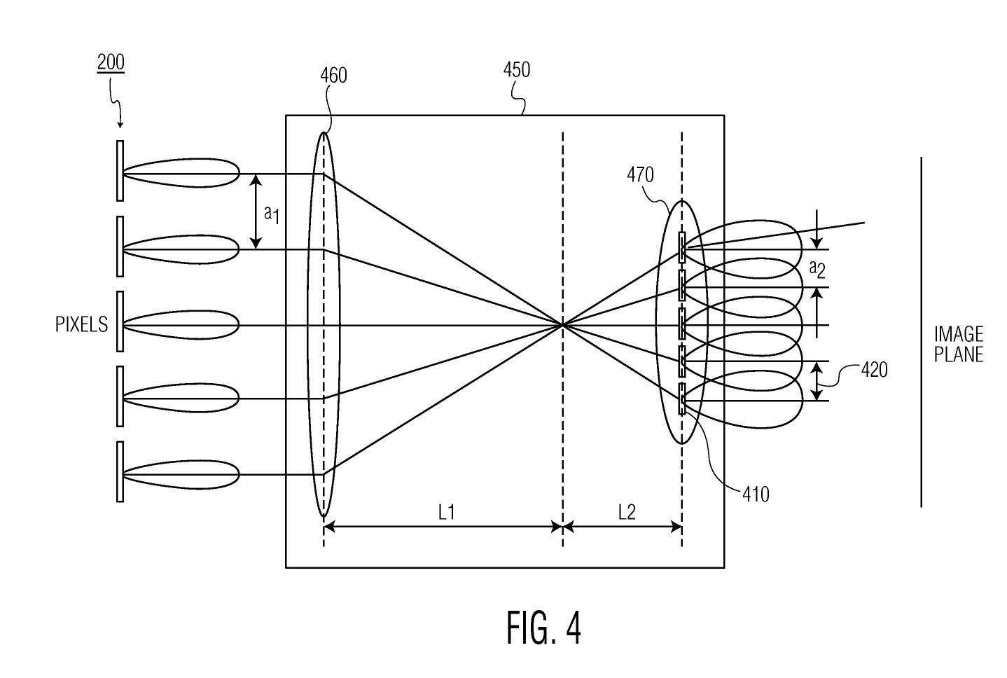

FIG. 4 shows an arrangement including an optical unit that can provide an “effective pixel pitch” that is significantly reduced with respect to the actual pixel pitch; and

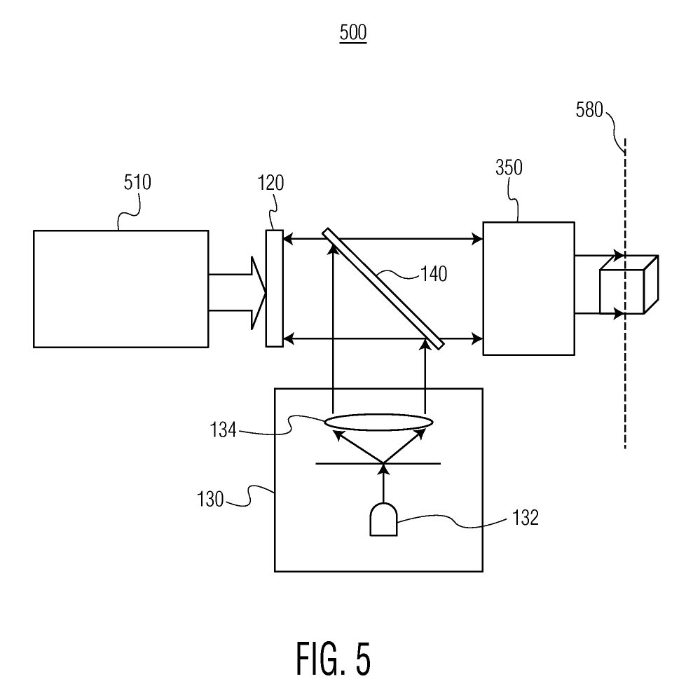

FIG. 5 shows an electroholographic display system that includes an optical unit that can provide an “effective pixel pitch” that is significantly reduced with respect to the actual pixel pitch.

FIG. 2 illustrates pixels 210 of a spatial light modulator (SLM) (e.g., a reflective LCD) 200 of an electroholographic display system, and an associated radiation pattern produced therefrom. Typically, pixels 210 are laid-out in a rectangular matrix of generally-orthogonal rows and columns. As shown in FIG. 2, the distance between the centers of adjacent pixels 210 is a₁, and is generally the same between any two adjacent pixels in the same row or column. This distance is referred to as the “pixel pitch” 220.

FIG. 2 shows the main-lobe diffraction pattern from each pixel 210 (the side lobes are not shown). The angle 2*θ₁ in FIG. 2 is referred to as the beamwidth. For the light rays following a straight line path perpendicular to both the pixel plane and the image plane 280, the time taken by the light to move from the pixel 210 to the image plane 280 is the same for all pixels 210. This means that the “phase” of the light arriving at image plane 280 perpendicularly to the pixel plane is the same. In other words, the beam of light from all the pixels 210 is collimated (parallel). The simplistic view offered above, called geometrical optics, does not represent the physics totally accurately, but is an approximation.

As discussed above, for a satisfactory range of diffraction for an electroholographic display system, SLM 200 needs to have a fine, minute pixel pitch 200—on the order of ˜1 μm. At present, unfortunately, there are no electronic display devices whose pixel pitch is ˜1 μm. However, in the case of a reflective LCD, there are SLM devices with a pixel pitch 220 on the order of 10 μm.

Accordingly, FIG. 3 shows one embodiment of an arrangement to provide an “effective pixel pitch” 320 that is significantly reduced with respect to the actual pixel pitch 220 of an SLM 200. The arrangement of FIG. 3 includes SLM 200 having pixels 210 laid-out in a rectangular matrix of generally-orthogonal rows and columns with pixel pitch 220 of a₁, and an optical unit 350 disposed between SLM 200 and image plane 380.

Optical unit 350 operates to produce an effective pixel pitch 320, as seen at image plane 380, of a₂<<of a₁. In one embodiment, a₁=N*a₂, where 5≦N≦50, and beneficially, 10≦N≦20. In that case, if actual pixel pitch 210 is 10 μm, then effective pixel pitch 310 is 0.5-1.0 μm.

Note that optical unit 350 neither requires an SLM 200 with smaller pixels 210, nor does it replicate such a device. It only mimics the effect of an SLM 200 with a reduced pixel pitch 210. For this reason, the “effective pixels” 310 having effective pixel pitch 320, have been shaded with grey instead of black in FIG. 3. Furthermore, optical unit 350 does not significantly change the relative phase of the radiation from its input to its output, so as to prevent degradation or disruption the generation of the object image at image plane 380. Meanwhile, as seen in FIG. 3, that the effective radiation pattern produced by each pixel 210 is widened by optical unit 350 so that the effective beamwidth is 2*θ₂>2*θ₁.

It is well known to optics experts that an optical unit can be used to either magnify an object, or to widen the viewing angle, but not both. In this case however, the pixel size is effectively reduced, and simultaneously the viewing angle is increased—both of which are good for an electroholographic display system.

FIG. 4 shows an arrangement including an optical unit 450, comprising first and second optical lenses 460, 470 having different focal lengths from each other. Beneficially, optical lenses 460 and 470 are each convex lenses having focal lengths L1=1/F1 and L2=1F2,respectively. Each lens 460, 470 is located one focal length away from a focal point F. Such a combination of lenses is frequently used to make telescopes. Optical unit 450 is one embodiment of optical unit 350 of FIG. 3. In this embodiment, the ratio of the effective pixel pitch 420 to the actual pixel pitch 220 is the same as the ratio of the focal length L1 of lens 460 to the focal length L2 of lens 470 (420/220=L1/L2). For example, if the focal length L1 of lens 460 is ten times the focal length L2 of lens 470, then the effective pixel pitch 420 is one tenth ( 1/10) of the actual pixel pitch 220 of SLM pixels 210. Meanwhile, the arrangement of FIG. 4 does not modify the relative phase of the light beam—the beam still remains collimated.

FIG. 5 shows one embodiment of an electroholographic display system 500 that includes optical unit 350 to provide an “effective pixel pitch” that is significantly reduced with respect to the actual pixel pitch of an SLM.

Electroholographic display system 500 comprises a processor and driver unit 510, spatial light modulator (SLM) 200, coherent light source 130, a beamsplitter 140, and an optical unit 350. Processor and driver unit 510 may comprise separate circuits or components of the processor and the driver, and may include memory such as read only memory (ROM), random access memory (RAM), etc. Beneficially, software for executing various algorithms is stored in memory in processor and driver unit 510. Beneficially, SLM 200 is a reflective liquid crystal display (LCD), such as a reflective liquid crystal on silicon (LCOS) device. In one embodiment, coherent light source 130 comprises a laser emitting diode (LED) 132 and collimation optics 134. Alternatively, another laser light generation device or other coherent light generator may be employed. In some embodiments, beamsplitter 140 may be omitted, provided that another means or optical configuration is provided for directing light from coherent light source 130 onto SLM 200, and modulated light from SLM 200 toward a desired image plane. As explained above, in one embodiment optical unit 350 includes first and second optical lenses 460, 470. Other arrangements are possible.

Operationally, LED 132 provides a light beam to collimation optics 134 which collimates and sizes the light beam appropriately for SLM 200. That is, beneficially, the light beam is sized and shaped so as to substantially completely illuminate all of the pixels 210 of SLM 200 simultaneously (in contrast to so-called scanning-color systems). The coherent, collimated light beam from light source 130 is provided to beamsplitter 140, which directs the coherent, collimated light beam onto SLM 200. Meanwhile, processor and driver unit 510 generates hologram data and applies the data to drive the pixels of SLM 200. In response to the data driving each of the pixels of SLM 200, the coherent, collimated light beam is spatially modulated to generate a spatially modulated light beam which is reflected back to beamsplitter 140. Beamsplitter passes the spatially modulated light beam therethrough to optical unit 350. Optical unit 350 processes the spatially modulated light beam to provide an “effective pixel pitch” 320 that is significantly reduced with respect to the actual pixel pitch 220 of SLM 200.

While the inclusion of optical unit 350 in the arrangement of FIG. 5 reduces the effective pitch of the pixels 210 of SLM 200, it also reduces the size of the object image at image plane 580 by the same factor. That reduction in image size can optionally be compensated by processor and drive unit 510 computing the hologram for an object or scene which is bigger than the desired object (or scene) image, so that the reduction of the image is compensated by increase in the size of the image in the computation of the hologram.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

1. An electroholographic display system (500), comprising:
a coherent light source (130) adapted to produce a coherent, collimated light beam;
a spatial light modulator (SLM) (120) adapted to receive and modulate the coherent collimated light beam to produce therefrom a modulated light beam, the SLM (120) including a plurality of pixels (210) having a pixel pitch (220) of a₁;
a processor and driver unit (510) adapted to generate hologram data representing a holographic image and to apply appropriate drive signals to the pixels of the SLM (120) to cause the SLM (1200 to modulate the coherent collimated light beam with the hologram data; and
an optical unit (350, 450) disposed to receive the modulated light beam and to produce therefrom the holographic image, wherein the effective pixel pitch (320, 420) of the holographic image is a₂<a₁.

2. The system (500) of claim 1, wherein a₁=N*a₂, where 5≦N≦50.

3. The system (500) of claim 1, wherein a₁=N*a₂, where 10≦N≦20.

4. The system (500) of claim 1, wherein the optical unit (350, 450) comprises first and second lenses (460, 470) arranged such that the modulated light beam passes successively through the first and second lenses (460, 470), wherein the first lens (460) has a first focal length, L1, that is greater than a second focal length, L2, of the second lens (470).

5. The system (500) of claim 4, wherein L1=N*L2, where 5≦N≦50.

6. The system (500) of claim 4, wherein L1=N*L2, where 10≦N≦20.

7. The system (500) of claim 1, wherein the SLM (120) is a reflective liquid crystal display (LCD) device.

8. The system (500) of claim 1, wherein the SLM (120) is a reflective liquid crystal on silicon (LCOS) device.

9. The system (500) of claim 1, wherein the coherent light source (130) includes a laser light generating device (132).

10. A method of displaying a holographic image, comprising:
providing a coherent, collimated light beam to a spatial light modulator (SLM) (120) comprising a plurality of pixels (210) having a pixel pitch (220) of a₁;
applying appropriate drive signals to the pixels of the SLM (120) to cause the SLM (120) to modulate the coherent collimated light beam with hologram data to produce therefrom a modulated light beam; and
optically processing the modulated light beam to provide a holographic image, wherein the effective pixel pitch (320, 420) of the holographic image is a₂<a₁.

11. The method of claim 10, wherein a₁=N*a₂, where 5≦N≦50.

12. The method of claim 10, wherein a₁=N*a₂, where 10≦N≦20.

13. The method of claim 10, wherein optically processing the modulated light beam to provide a holographic image comprises passing the modulated light beam successively through the first and second lenses (460, 470), wherein the first lens (460) has a first focal length, L1, that is greater than a second focal length, L2, of the second lens (470).

14. The method of claim 13, wherein L1=N*L2, where 5≦N≦50.

15. The method of claim 14, wherein L1=N*L2, where 10≦N≦20.

16. The method of claim 10, wherein the SLM (120) is a reflective liquid crystal display (LCD) device.

17. The method of claim 10, wherein the SLM (120) is a reflective liquid crystal on silicon (LCOS) device.

18. The method of claim 10, wherein providing the coherent light source (130) includes providing light from a laser light generating device (132).
